(19) United States
(12) Patent Application Publication
(10) Pub. No.: US 2008/0291137 A1
(43) Pub. Date: Nov. 27, 2008

(54) DRIVER DEVICE FOR AN ORGANIC EL PASSIVE MATRIX DEVICE

(75) Inventor: Nobuhiko TSUJI, Yokosuka city (JP)

Correspondence Address: ROSSI, KIMMS & McDOWELL LLP., 20609 Gordon Park Square, Suite 150, Ashburn, VA, 20147, US

(73) Assignee: FUJI ELECTRIC HOLDINGS CO., LTD., Kawasaki-ku (JP)

(21) Appl. No.: 12/125,482

(22) Filed: May 22, 2008

(30) Foreign Application Priority Data
May 22, 2007 (JP) 2007-135856

(51) Int. Cl. G09G 3/30

(52) U.S. Cl. 345/76

(57) ABSTRACT

A driver device is provided for an organic EL passive matrix device that achieves reduction in power consumption and suppression of uneven luminance at a low cost. The driver device includes a column driver, a first row driver, a second row driver, a memory, and a power supply/control signal input. An anode of each organic EL element of the organic EL passive matrix device is connected to an output of the column driver, and cathodes in a row are connected together to an input of the row driver. In the driver device, the column driver is disposed in the vicinity of one peripheral side of the IC, and each of the row drivers is disposed in the vicinity of one of the two peripheral sides adjacent to the peripheral side at which the column driver is disposed. These three drivers are packaged on a single integrated chip (IC) chip.

### CROSS-REFERENCE TO RELATED APPLICATION

This application is based on, and claims priority from, Japanese Patent Application No. 2007-135856, filed on May 22, 2007, the contents of which are incorporated herein by reference.

### BACKGROUND

The present invention relates to a driver device for an organic EL passive matrix device, and in particular, to a driver device having two row drivers, for an organic EL passive matrix device.

Organic EL devices are expected to be applied to next generation displays. A passive matrix system is one of driving systems to make an organic EL device to emit light. The system composes a matrix of electrode lines in rows and columns and drives organic EL elements (corresponding to pixels) arranged on points of intersection of the lines.

FIG. 1 shows a driver device generally employed for driving an organic EL device 110 in the passive matrix system (hereinafter referred to as an organic EL passive matrix device). The driver device 100 is provided with a column driver 101 and a row driver 102. An organic EL passive matrix device 110 is composed of organic EL elements arranged in m columns and n rows. Anodes of the organic EL elements are connected to outputs of the column driver 101 and cathodes of the organic EL elements in every row are connected to a corresponding input of the row driver 102. When the cathode line 1 of the row driver 102 solely is turned to a low electric potential level, electric current I₁, . . . , Iₘ flows in the column direction in proportion to external luminance signals (not shown in FIG. 1) to light the organic EL elements. Subsequently, the cathode lines 2 to m of the row driver 102 are sequentially made to a low potential level to light every set of the organic EL elements in one row of the organic passive matrix device 110. This procedure is called a sequential scanning. The driver device 100 displays a predetermined pattern and an image on the organic EL passive matrix device 110 repeating this procedure.

The minimum necessary voltage Vₛ of a power supply for driving the driver device 100 is represented by the equation (1).

Vₛ=V₁+V₂+V₃+V_{cm}+V₄ (1)

where V_{ci} (i=1, 2, . . . , m) is a voltage drop between a cathode terminal of the organic EL element i and an input terminal of the row driver 102 connected to the cathode terminal, and V_{cm} is a voltage drop from the cathode terminal of the organic EL elements arranged at m-th column. Power consumption P is a product of the voltage Vₛ and a current I that is a sum of the driving current I₁, . . . , and Iₘ.

The voltage drop V_{ci} is generated by a resistance in the wiring (the cathode line) between the cathode terminal of the organic EL element at i-th column and the input terminal of the row driver 102 to which the cathode terminal is connected. The voltage drop V_{ci} increases by shifting in the column direction (pixel direction) (in the direction from i=1 to m), as shown in FIG. 2. The figure shows a linear increase for simplicity although not strictly linear in actual. Let r be a wiring resistance between adjoining pixels and I be a constant current in every pixel, V_{cm} can be represented by equation (2).

V_{cm}=lr+2lr+3lr+ . . . +mlr (2)

When the power supply voltage Vₛ is applied, a reactive power is generated due to the difference of voltage in the column direction (pixel direction). The reactive power equals a product of the reactive voltage Vₛ shown in FIG. 2 and the current. The reactive power grows so large that it cannot be ignored with expansion of the display area.

In a 2.8 inch QVGA (240 RGB pixels×320 rows) for example, the resistance is about 100Ω provided the total length of the cathode line of each row is 45 mm and the thickness of the material of aluminum is 100 nm. When a current of 150 μA is fed to every pixel, the voltage drop V_{cm} is 5.7 V, the corresponding power equals 5.7 V×150 μA×240×3 (RGB), a half of which is a reactive power. Thus, there exists a problem of excessively large reactive power in a generally employed driver device in which the driving current is sunk by a single row driver.

The variation of wiring resistance in the pixel direction causes a problem of unevenness of luminance in addition to the problem of power. The variation in wire resistance causes variation in building-up characteristic at the pixels and variation in emitting time, resulting in the unevenness of luminance.

Japanese Unexamined Patent Application Publication No. H09-281928 discloses a technology to solve the problems of power consumption and uneven luminance by connecting a cathode scanning circuit, which is analogous to the row driver, to both terminals of a cathode line. Japanese Unexamined Patent Application Publication No. 2006-235162 also discloses a similar technology, in which a first and a second change-over mechanism of scanning lines are provided, the mechanism being analogous to the row driver, and a selected scanning line (analogous to the cathode line) is grounded to reduce unevenness of display due to the wiring resistance.

FIG. 3 shows a driver device similar to the one disclosed in Japanese Unexamined Patent Application Publication No. H09-281928 and Japanese Unexamined Patent Application Publication No. 2006-235162. The driver device 300 is provided with a column driver 301 and two row drivers 302 and 303 which are arranged at the both sides of the cathode lines within the organic EL passive matrix device 310

FIG. 4 shows the voltage drop due to wire resistance in the driver device provided with two row drivers. The current running in the cathode resistance is sunk to the two row drivers, thereby reducing variation of the wiring resistance in the column direction (pixel direction), and particularly reducing voltage drop at the end of the cathode line.

In a 2.8 inch QVGA (240 RGB pixels×320 rows) for example, the resistance is about 50Ω provided the total length in the half side of the cathode line is about 22.5 mm and the thickness of aluminum is 100 nm. When a current of 150 μA is fed to every pixel, the V_{cm} is 1.4 V and the corresponding power equals 1.4 V×150 μA×240×3 (RGB). The reactive power is reduced to ¼ as compared with the foregoing example. Since the voltage V₄ in the row driver is halved, the power supply voltage can be further reduced. Thus, the reactive power and the power due to the cathode resistance are improved. With decrease in voltage variation in the column direction (pixel direction), variation in build-up characteristic also decreases to reduce unevenness in luminance.

Enlargement of display area raises a problem of increased power consumption in addition to the problem caused by the wiring resistance. Expanded display area shortens the time allowed to feed a current in each row. When a large-sized EL passive matrix device of 2.8 inch QVGA (240 RGB pixels×320 rows) for example, is driven by a set of a column driver and a row driver, a scanning period is 1/320. This requires increase in current in order to ensure desired luminance, causing increase in power consumption in the organic EL elements.

Japanese Unexamined Patent Application Publication No. 2006-047511 discloses that a driver device of a dual scanning system is employed in which two LSIs each integrating a column driver and a row driver on one chip with increase in the display area. By using two LSIs, the time allowed to feed current to each row can be doubled as compared with the case of one LSI, suppressing the current at a low level.

The conventional technologies as mentioned in the foregoing can mitigate, in some degree, the problems of the increase in power consumption and generation of uneven luminance due to enlargement of an organic EL passive matrix device. However, application to a large area display requires further improvement for solving such problems. Besides, the improvement is desired to be achieved at a low cost.

### SUMMARY OF THE INVENTION

The present invention provides a driver device for an organic EL passive matrix device that achieves reduction of power consumption and suppression of unevenness in luminance in the organic EL passive matrix device at a low cost.

Specifically, a driver device for an organic EL passive matrix device is provided that has a plurality of anode lines and a plurality of cathode lines arranged in a matrix form and organic EL elements arranged at points of intersection of the lines. The driver device comprises a column driver connecting to one end of the plurality of anode lines and, first and second row drivers, one of the row drivers connecting to an end of the plurality of cathode lines and the other of the row drivers connecting to the other end of the plurality of cathode lines. The column driver feeds current through selected anode line of the plurality of anode lines. The first and second row drivers sink the current fed by the column driver through selected cathode lines of the plurality of cathode lines. The column driver, the first row driver, and the second row driver are integrated in a single integrated circuit (IC).

The column driver is preferably disposed in a vicinity of a peripheral side of the IC, and the first row driver is disposed in the vicinity of one peripheral side adjacent to the peripheral side at which the column driver is disposed, and the second row driver is disposed in a vicinity of another peripheral side adjacent to the peripheral side at which the column driver is disposed.

The column driver is preferrably disposed in a vicinity of a peripheral side of the IC, and the first row driver is angled and disposed in a vicinity of the column driver and in a vicinity of one peripheral side adjacent to the peripheral side at which the column driver is disposed, and the second row driver is angled and disposed in a vicinity of the column driver and in a vicinity of another peripheral side adjacent to the peripheral side at which the column driver is disposed.

The driver device preferably includes two partial driver devices each being any one of the driver devices for an organic EL passive matrix device and disposed at each end region of the anode lines of the organic EL passive matrix device, and the two partial driver devices being connected through a wire and operated in synchronism with each other, and sharing the driving function on the organic EL passive matrix device.

Further, the organic EL passive matrix device preferably has pixels at least 240 RGB pixels×at least 320 rows.

The present invention provides such a driver device for an organic EL passive matrix device that achieves reduction in power consumption and suppression of uneven luminance by providing two row drivers at both ends of cathode lines, at a low cost by virtue of packaging a column driver and two row drivers in a single IC.

### BRIEF DESCRIPTION OF THE DRAWINGS

The invention will be described with reference to certain preferred embodiments and the accompanying drawings wherein:

FIG. 1 shows a driver device for an organic EL passive matrix device of a prior art;

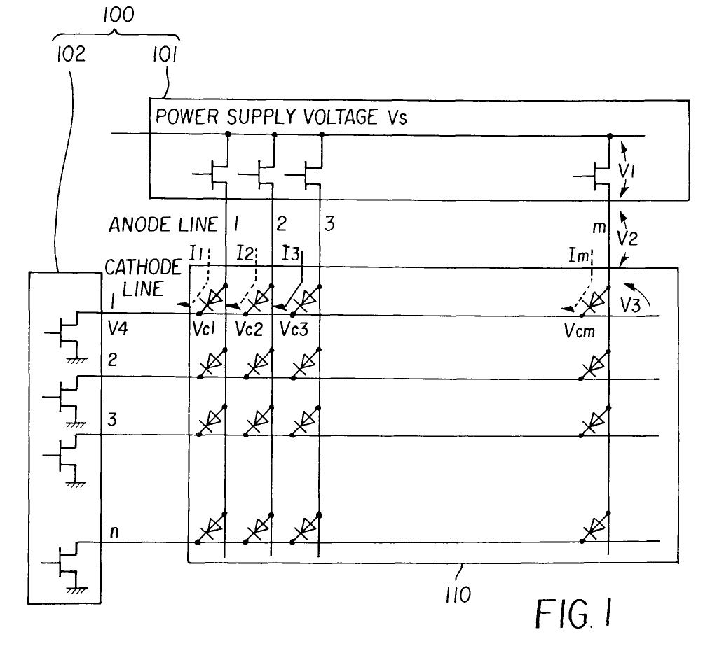

FIG. 2 shows s relationship between the voltage drop and the column direction in the driver device of FIG. 1;

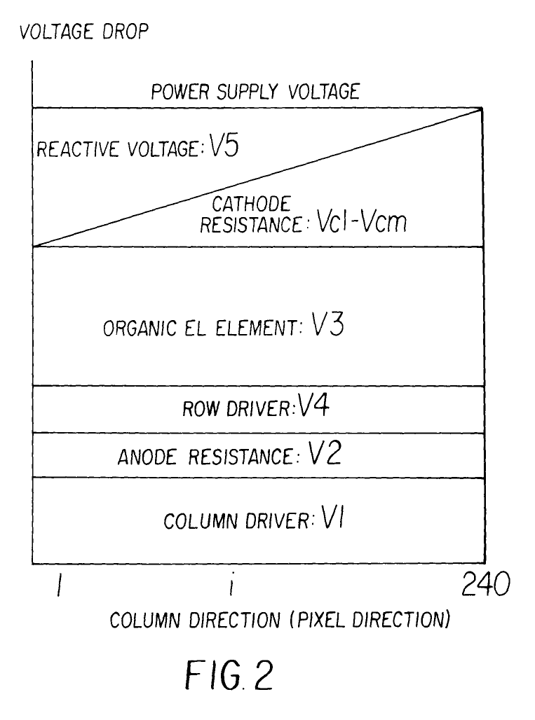

FIG. 3 shows a driver device for an organic EL passive matrix device of another prior art;

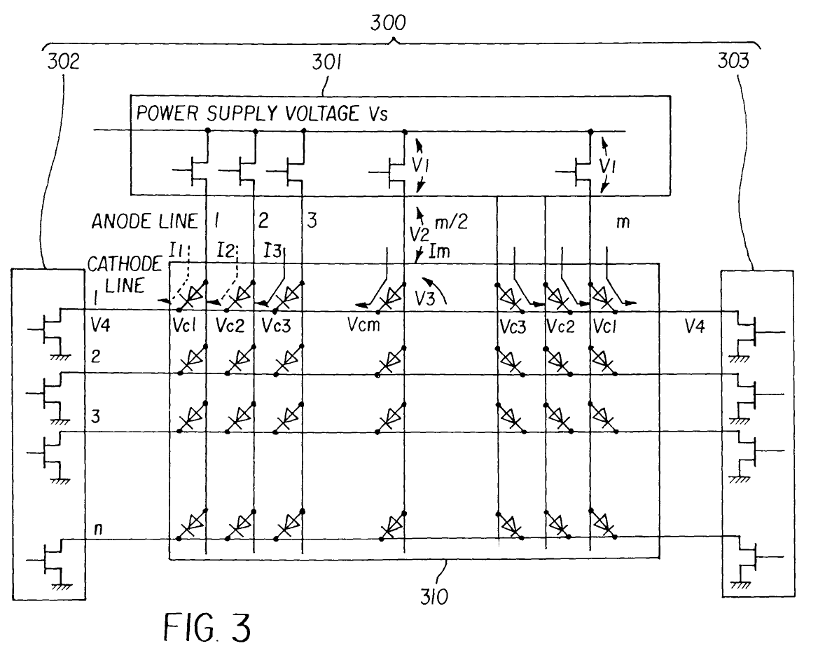

FIG. 4 shows a relationship between the voltage drop and the column direction in the driver device of FIG. 3;

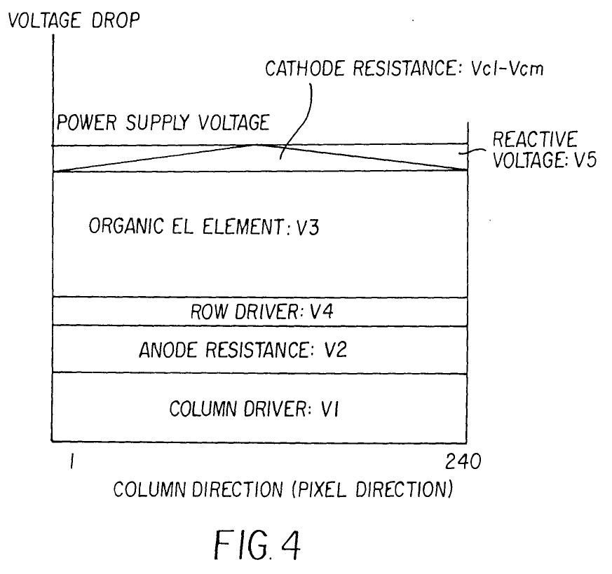

FIG. 5 shows a driver device for an organic EL passive matrix device of the first embodiment according to the invention;

FIG. 6 shows a modification in the first embodiment; and

FIG. 7 shows a driver device for an organic EL passive matrix device of the second embodiment according to the invention.

### DETAILED DESCRIPTION OF THE INVENTION

### Example 1

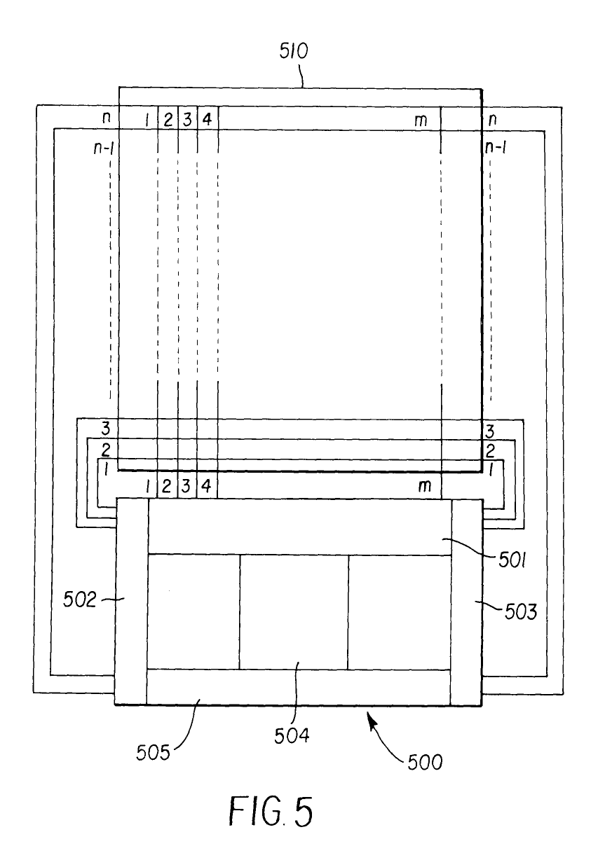

FIG. 5 shows a driver device for an organic EL passive matrix device of a first embodiment example according to the invention. The driver device 500 drives an organic EL passive matrix device 510 having m columns and n rows. The driver device 500 comprises a column driver 501, a first row driver 502, a second row driver 503, a memory 504, and a power supply/control signal input 505. An anode of each organic EL element of the organic EL passive matrix device 510 is connected to an output of the column driver 501, and cathodes of each row are connected to inputs of the row drivers 502 and 503.

The power supply/control signal input 505 accepts a power and a control signal from outside and feeds the power and the signal to the column driver 501, the first row driver 502, the second row driver 503, and the memory 504. The power and the signal are, for example, a power supply voltage Vs for the column driver 501 and write-in display data for the memory 504.

The driver device of this embodiment example is featured by that a column driver 501 and row drivers 502 and 503 are packaged in a single IC in the arrangement as shown in FIG. 5. The column driver 501 is disposed in the vicinity of one peripheral side of the IC. The first row driver 502 is disposed in the vicinity of a peripheral side adjacent to the peripheral side at which the column driver 501 is disposed, and the second row driver 503 is disposed in the vicinity of another peripheral side adjacent to the peripheral side at which the column driver 501 is disposed. Although the increase in the number of row drivers from one to two is a cost-increasing factor, due to the three driver sections, a low cost can be achieved by packaging the three sections in a single unit.

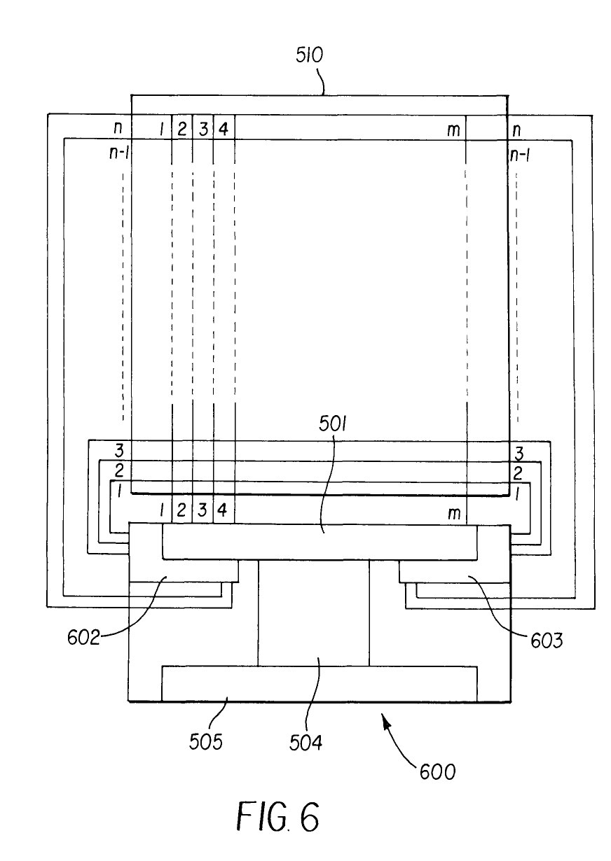

FIG. 6 shows a modification in a driver device in this embodiment example. The driver device 600 comprises the same components as in the driver device 500 except for the row drivers. The first and second row drivers 602 and 603 are angled. Each of the drivers is disposed in the vicinity of the column driver 501 and in the vicinity of a peripheral side adjacent to the peripheral side at which the column driver 501 is disposed. The configuration of this driver device 600 is useful in the case in which the size of the IC for packaging the driver devices is confined in the direction of the peripheral side adjacent to the peripheral side at which the column driver 501 is disposed.

As described above, a driver device of this first embodiment example (including the modification) achieves reduction in power consumption and suppression of uneven luminance by providing two row drivers at both ends of the cathode lines, at a low cost by virtue of packaging a column driver and two row drivers in a single IC.

### Example 2

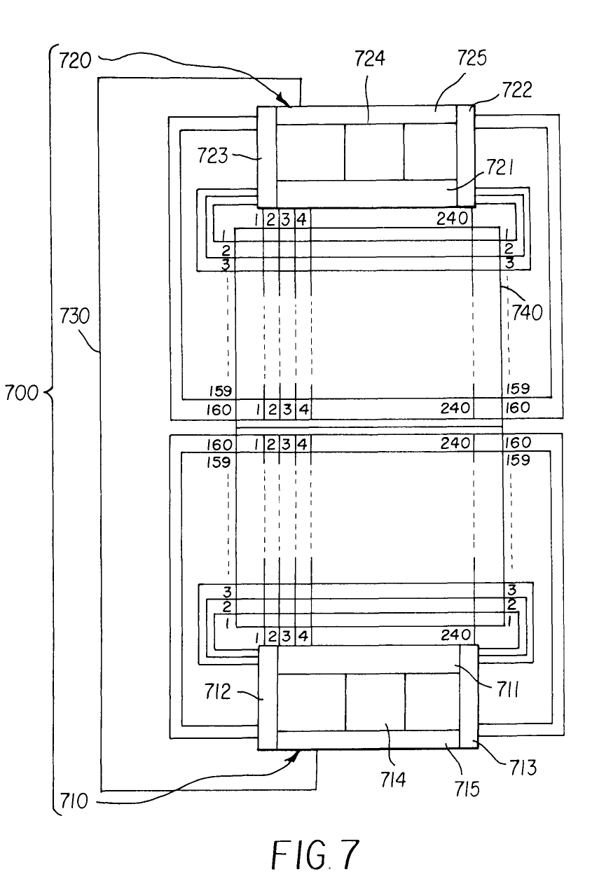

FIG. 7 shows a driver device for an organic EL passive matrix device of a second embodiment example according to the invention. The driver device 700 comprises a first partial driver device 710 that is a device of Example 1, a second partial driver device 720 that is another device of Example 1, and a connector 730 connecting the first partial driver device 710 and the second partial driver device 720. The first and second partial driver devices 710 and 720 are disposed at both ends of anode lines of an organic EL passive matrix device 740 and drive the organic EL passive matrix device 740 separately in two sections in synchronism with each other through the connector 730.

The power supply/control signal inputs 715 and 725 accept a power and a control signal from outside and feeds the power and the signal to the column drivers 715 and 725, respectively. Driver device 710 includes two row drivers 712 and 713. Likewise, driver device 720 includes two row drivers 722 and 723. In addition, the power and signal are fed to the column drivers 711,721, row drivers 712,713 and the memory 714 and 724

In the case of a large-sized organic EL passive matrix device such as a 2.8 inch QVGA (240 RGB pixels×320 rows), a scanning period becomes 1/320 and current has to be increased in the conventional devices. However, the separated driving in two sections as in the invention elongates the scanning period from 1/320 to 1/160. As a result, the driving current for the organic EL elements can be halved to reduce the power consumption to a half or less as compared with the conventional devices, yet ensuring necessary luminance. Moreover, the voltage drop due to anode resistance and power consumption are also reduced.

Meanwhile, the anode resistance is due to a transparent electrode material such as indium-zinc ozide (IZO). In the case of a 2.8 inch device, the resistance is about 12 kΩ assuming the length of the anode line of 60 mm and the thickness of IZO of 440 nm. Feeding a current of 150 μA, the voltage drop V₂ due to the anode resistance amounts-up to 1.8 V (12 kΩ×0.15 mA). When divided into two sections, this value can be halved.

In order to make the two separated areas into one picture, the two ICs are connected through the connector 730 and the upper and lower sections are synchronized in the row direction (scanning direction) using the column (pixel) data in each section to display the organic EL passive matrix device.

As described above, a driver device of this second embodiment example, in which first and second partial driver devices each having two row drivers are provided at both ends of anode lines of the organic EL passive matrix device, and drives the organic EL passive matrix device separately. As a result, further reduction in power consumption is achieved.

The invention has been described with reference to certain preferred embodiments thereof. It will be understood, however, that modifications and variations are possible within the scope of the appended claims.

What is claimed is:

1. A driver device for an organic EL passive matrix device having a plurality of anode lines and a plurality of cathode lines arranged in a matrix form and organic EL elements arranged at points of intersection of the lines, the driver device comprising:
a column driver that feeds current through selected anode lines of the plurality of anode lines and is connected to one end region of the plurality of anode lines; and
first and second row drivers that sink the current fed by the column driver through selected cathode line of the plurality of cathode lines, one of the row drivers connecting to an end region of the plurality of cathode lines and the other of the row drivers connecting to the other end region of the plurality of cathode lines;
wherein the column driver, the first row driver, and the second row driver are integrated in a single integrated circuit (IC).

2. The driver device for an organic EL passive matrix device according to claim 1, wherein the column driver is disposed in a vicinity of a peripheral side of the IC, wherein the first row driver is disposed in the vicinity of one peripheral side adjacent to the peripheral side at which the column driver is disposed, and wherein the second row driver is disposed in a vicinity of another peripheral side adjacent to the peripheral side at which the column driver is disposed.

3. The driver device for an organic EL passive matrix device according to claim 1, wherein the column driver is disposed in a vicinity of a peripheral side of the IC, wherein the first row driver is angled and disposed in a vicinity of the column driver and in a vicinity of one peripheral side adjacent to the peripheral side at which the column driver is disposed, and wherein the second row driver is angled and disposed in a vicinity of the column driver and in a vicinity of another peripheral side adjacent to the peripheral side at which the column driver is disposed.

4. A driver device for an organic EL passive matrix device including two sections, each section having a plurality of anode lines and a plurality of cathode lines arranged in a matrix form and organic EL elements arranged at points of intersection of the lines, the driver device comprising comprising:
a first partial driver device;
a second partial driver device; and
a connector connecting the first partial driver device and the second partial driver device;
wherein the first and second partial driver devices are respectively disposed at the ends of the anode lines of the first and second sections of the organic EL passive matrix device;
wherein the first and second partial drivers drive the first and second sections of the organic EL passive matrix device separately in synchronism with each other; and
wherein the first and second partial drivers each comprise:
a column driver that feeds current through selected anode lines of the plurality of anode lines and is connected to one end region of the plurality of anode lines; and
first and second row drivers that sink the current fed by the column driver through selected cathode line of the plurality of cathode lines, one of the row drivers connecting to an end region of the plurality of cathode lines and the other of the row drivers connecting to the other end region of the plurality of cathode lines, wherein the column driver, the first row driver, and the second row driver are integrated in a single integrated circuit (IC).

5. The driver device for an organic EL passive matrix device according to claim 4, wherein the column driver is disposed in a vicinity of a peripheral side of the IC, wherein the first row driver is disposed in the vicinity of one peripheral side adjacent to the peripheral side at which the column driver is disposed, and wherein the second row driver is disposed in a vicinity of another peripheral side adjacent to the peripheral side at which the column driver is disposed.

6. The driver device for an organic EL passive matrix device according to claim 4, wherein the column driver is disposed in a vicinity of a peripheral side of the IC, wherein the first row driver is angled and disposed in a vicinity of the column driver and in a vicinity of one peripheral side adjacent to the peripheral side at which the column driver is disposed, and wherein the second row driver is angled and disposed in a vicinity of the column driver and in a vicinity of another peripheral side adjacent to the peripheral side at which the column driver is disposed.

7. The driver device for an organic EL passive matrix device according to claim 1, wherein the organic EL passive matrix device has pixels at least 240 RGB pixels×at least 320 rows.

8. The driver device for an organic EL passive matrix device according to claim 2, wherein the organic EL passive matrix device has pixels at least 240 RGB pixels×at least 320 rows.

9. The driver device for an organic EL passive matrix device according to claim 3, wherein the organic EL passive matrix device has pixels at least 240 RGB pixels×at least 320 rows.

10. The driver device for an organic EL passive matrix device according to claim 4, wherein the organic EL passive matrix device has pixels at least 240 RGB pixels×at least 320 rows.

11. The driver device for an organic EL passive matrix device according to claim 5, wherein the organic EL passive matrix device has pixels at least 240 RGB pixels×at least 320 rows.

12. The driver device for an organic EL passive matrix device according to claim 6, wherein the organic EL passive matrix device has pixels at least 240 RGB pixels×at least 320 rows.
